(19) United States
(12) Patent Application Publication
(10) Pub. No.: US 2013/0083714 A1
(43) Pub. Date: Apr. 4, 2013

(54) RADIO COMMUNICATION SYSTEM, RADIO BASE STATION, AND COMMUNICATION CONTROL METHOD

(71) Applicants: Shingo Joko, Kawasaki-shi (JP); Mitsuhiro Kitaji, Yokohama-shi (JP); Kenta Okino, Yokohama-shi (JP)

(72) Inventors: Shingo Joko, Kawasaki-shi (JP); Mitsuhiro Kitaji, Yokohama-shi (JP); Kenta Okino, Yokohama-shi (JP)

(73) Assignee: KYOCERA CORPORATION, Kyoto (JP)

(21) Appl. No.: 13/704,203

(22) PCT Filed: Jun. 15, 2011
(86) PCT No.: PCT/JP2011/063691

§ 371 Date: Dec. 13, 2012

(30) Foreign Application Priority Data
Jun. 18, 2010 (JP) 2010-140007

(51) Int. Cl. H04W 52/02

(52) U.S. Cl. CPC H04W 52/0206
USPC 370/311

(57) ABSTRACT

After the radio base station eNB#2 receives a Configuration Update message from the radio base station eNB#1, the message including Deactivation Indication IE indicating that the radio base station eNB#1 is switched to the inactive state, the radio base station eNB#2 sends, to the radio base station eNB#1, a Cell Activation Request message for switching the radio base station eNB#1 to an active state depending on a condition of a radio terminal UE connected to the radio base station eNB#2.

### TECHNICAL FIELD

The present invention relates to a radio communication system, a radio base station, and a communication control method to which a SON technique is applied.

### BACKGROUND ART

LTE (Long Term Evolution) standardized in 3GPP (3rd Generation Partnership Project) being a standardization organization for radio communication systems employs SON (Self Organizing Network) techniques by which a radio base station is enabled to change its own settings without human intervention.

Energy saving is one of the SON techniques for cutting down power consumption of a radio base station, by switching the state of the radio base station to an inactive state of reduced power consumption (see Non-Patent Literature 1).

In energy saving, a radio base station is capable of notifying another radio base station that the radio base station is switched to the inactive state, or of requesting another radio base station to be switched to the active state (see Non-Patent Literature 2).

### CITATION LIST

### Non-Patent Literature

Non-Patent Literature 1: 3GPP TR36.902 V9.1.0

Non-Patent Literature 2: 3GPP TS36.423 V9.2.0

### SUMMARY OF THE INVENTION

However, Non-Patent Literatures 1 and 2 do not clearly define, for energy saving, judgment criteria for such notifications and requests between radio base stations. Hence, energy saving has room for improvement in providing a favorable service to radio terminals while cutting down power consumption of the radio base stations.

Against this background, an objective of the present invention is to provide a radio communication system, a radio base station, and a communication control method capable of providing a favorable service to radio terminals while cutting down power consumption of the radio base stations.

In order to solve the aforementioned problem, the present invention has following features.

First, the feature of a radio communication system according to the present invention is summarized as follows. A radio communication system comprises: a first radio base station (radio base station eNB#1 or RRH#1) capable of being switched from an active state to an inactive state in which the first radio base station consumes less power than in the active state; a second radio base station (radio base station eNB#2 or RRH#2)in the neighborhood of the first radio base station; and a controller (controller 220 or control device 300) configured to perform control when the first radio base station is in the inactive state, such that the first radio base station is switched from the inactive state to the active state depending on a condition of a radio terminal connected to the second radio base station.

According to this feature, power consumption of the first radio base station can be reduced, while the first radio base station can be switched from the inactive state to the active state in consideration of the possibility that the radio terminal connected to the second radio base station switches its connection destination to the first radio base station. Hence, it is possible to provide a favorable service to the radio terminal, while cutting down power consumption of the radio base station.

Another feature of the radio communication system according to the present invention is summarized as follows. In the radio communication system according to the aforementioned feature, the first radio base station sends, to the second radio base station, deactivation information (Deactivation Information IE) indicating that the first radio base station is switched to the inactive state, the second radio base station comprises: the controller; a receiver (network communication unit 240) configured to receive the deactivation information from the first radio base station; and a transmitter (network communication unit 240) capable of sending, to the first radio base station, an activation request (Cell Activation Request) for switching the first radio base station to the active state, and after the receiver receives the deactivation information, the controller controls the transmitter so that the transmitter sends the activation request to the first radio base station, depending on the situation of the radio terminal connected to the second radio base station.

Another feature of the radio communication system according to the present invention is summarized as follows. In the radio communication system according to the aforementioned feature, after the receiver receives the deactivation information, the controller controls the transmitter so that the transmitter sends the activation request to the first radio base station, when at least one radio terminal connected to the second radio base station satisfies a condition for switching its connection destination to the first radio base station.

Another feature of the radio communication system according to the present invention is summarized as follows. In the radio communication system according to the aforementioned feature, after the receiver receives the deactivation information, the controller controls the transmitter so that the transmitter sends the activation request to the first radio base station, when the number of radio terminals connected to the second radio base station and located within a predetermined area from the first radio base station exceeds a predetermined number.

Another feature of the radio communication system according to the present invention is summarized as follows. In the radio communication system according to the aforementioned feature, after the receiver receives the deactivation information, the controller controls the transmitter so that the transmitter sends the activation request to the first radio base station, when the number of radio terminals connected to the second radio base station and traveling toward the first radio base station exceeds a predetermined number.

Another feature of the radio communication system according to the present invention is summarized as follows. In the radio communication system according to the aforementioned feature, after the receiver receives the deactivation information, the controller controls the transmitter so that the transmitter sends the activation request to the first radio base station, when the number of radio terminals connected to the second radio base station and having a lower level of power received from the second radio base station than a threshold exceeds a predetermined number.

The feature of a radio base station according to the present invention is summarized as follows. A radio base station (radio base station eNB#2) comprises: a receiver (network communication unit 240) configured to receive deactivation information (Deactivation Information IE) from other radio base station (radio base station eNB#1) in the neighborhood of the radio base station, the deactivation information indicating that the other radio base station is switched to an inactive state of reduced power consumption; a transmitter capable of sending the other radio base station an activation request (Cell Activation Request)for switching the other radio base station from the inactive state to an active state; and a controller (controller 220) configured to control the transmitter so that the transmitter sends the activation request to the other radio base station depending on a situation of a radio terminal (radio terminal UE) connected to the radio base station, after the receiver receives the deactivation information.

The feature of a communication control method according to the present invention is summarized as follows. A communication control method comprises the steps of: sending deactivation information from a first radio base station to a second radio base station in the neighborhood of the first radio base station, the deactivation information indicating that the first radio base station is switched to an inactive state of reduced power consumption; receiving the deactivation information from the first radio base station by the second radio base station; and after receiving the deactivation information, sending an activation request from the second radio base station to the first radio base station, the activation request being for switching the first radio base station from the inactive state to an active state depending on a situation of a radio terminal connected to the second radio base station.

### BRIEF DESCRIPTION OF THE DRAWINGS

FIG. 1 is a view for describing an outline of an LTE system.

FIG. 2 is a schematic configuration diagram showing a schematic configuration of a radio communication system of a first embodiment to a third embodiment.

FIG. 3 is a block diagram showing the configuration of the radio base station eNB#1 of the first embodiment to the third embodiment.

FIG. 4 is a block diagram showing the configuration of the radio base station eNB#2 of the first embodiment.

FIG. 5 is an operation sequence chart showing an operation of the radio communication system of the first embodiment.

FIG. 6 is a block diagram showing the configuration of the radio base station eNB#2 of the second embodiment.

FIG. 7 is an operation sequence chart showing an operation of the radio communication system of the second embodiment.

FIG. 8 is a block diagram showing the configuration of the radio base station eNB#2 of the third embodiment.

FIG. 9 is an operation sequence chart showing an operation of the radio communication system of the third embodiment.

FIG. 10 is a schematic configuration diagram showing a schematic configuration of a radio communication system of other embodiments.

### DESCRIPTION OF THE EMBODIMENTS

With reference to the drawings, a description is given of a first embodiment to a third embodiment and other embodiments of the present invention. In the drawings of each of the following embodiments, the same or similar reference signs are applied to the same or similar parts.

### (1) First Embodiment

A description is given of the first embodiment of the present invention in the order of: (1.1) Outline of LTE System; (1.2) Configuration of Radio Communication System; (1.3) Configurations of Radio Base Stations; (1.4) Operation of Radio Communication System; and (1.5) Effects of First Embodiment.

### (1.1) Outline of LTE System

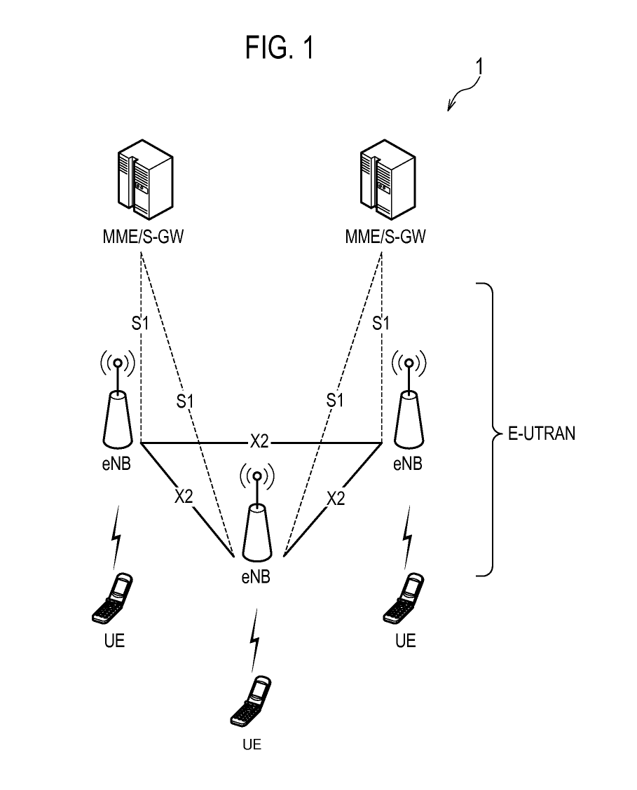

FIG. 1 is a view for describing an outline of an LTE system.

As shown in FIG. 1, multiple radio base stations eNB form an E-UTRAN (Evolved-UMTS Terrestrial Radio Access Network). Each of the multiple radio base stations eNB forms a cell which is a communication area for providing a service to a radio terminal UE. The radio terminal UE is a radio communication device held by a user, and is also referred to as a user device.

Neighboring radio base stations eNB can communicate with each other via an X2 interface being a logical communication path providing inter-base station communication. Each of the multiple radio base stations eNB can communicate with an EPC (Evolved Packet Core), namely, an MME (Mobility Management Entity) or an S-GW (Serving Gateway) via an S1 interface.

### (1.2) Configuration of Radio Communication System

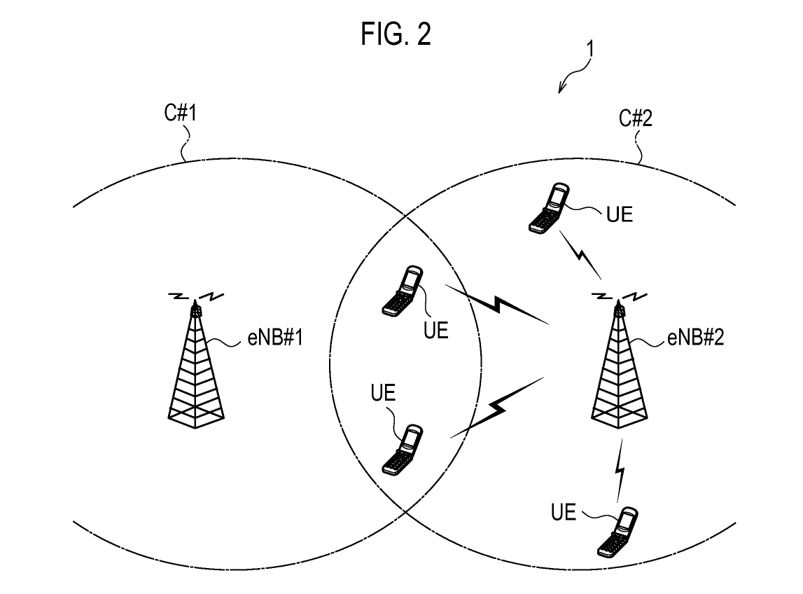

FIG. 2 is a schematic configuration diagram showing a schematic configuration of a radio communication system 1A of a first embodiment.

As shown in FIG. 2, the radio communication system 1A includes a radio base station eNB#1 forming a cell C#1 and a radio base station eNB#2 being in the neighborhood of the radio base station eNB#1 and forming a cell C#2. In the first embodiment, the radio base station eNB#1 corresponds to a first radio base station and the radio base station eNB#2 corresponds to a second radio base station.

Moreover, the radio communication system 1A includes multiple radio terminals UE connected to the radio base station eNB#2 in the cell C#2. The radio base station eNB#2 performs radio communication with the radio terminals UE connected to the radio base station eNB#2. Here, the “connection” of the radio terminal UE to the radio base station eNB#2 is considered to be a state in which the radio terminal UE is communicating (in a Connected state) with a communication destination via the radio base station eNB#2. The concept of the “connection” may also encompass a state in which the radio terminal UE is in a standby state against the radio base station eNB#2 (in an Idle state).

The radio base station eNB#1 and the radio base station eNB#2 can perform inter-base station communication over the aforementioned X2 interface.

### (1.3) Configurations of Radio Base Stations

Next, configurations of the radio base stations are described in the order of (1.3.1) configuration of radio base station eNB#1, and (1.3.2) configuration of radio base station eNB#2.

### (1.3.1) Configuration of Radio Base Station eNB#1

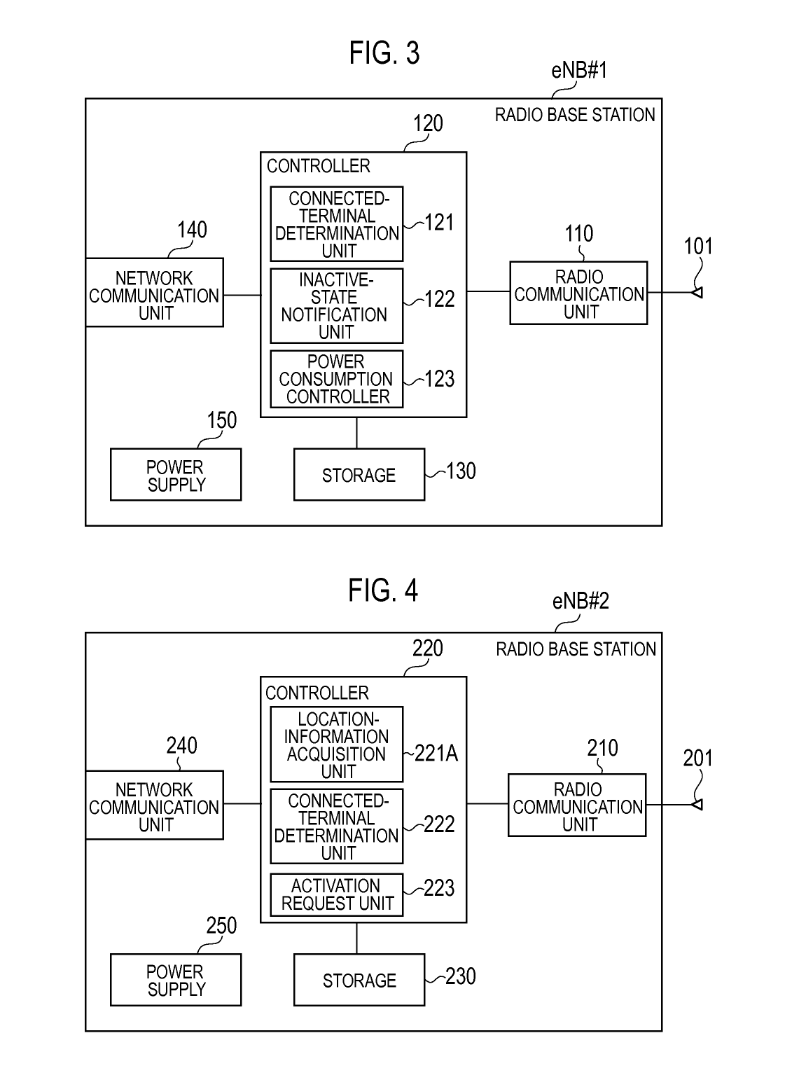

FIG. 3 is a block diagram showing the configuration of the radio base station eNB#1.

As shown in FIG. 3, the radio base station eNB#1 includes an antenna 101, a radio communication unit 110, a controller 120, a storage 130, and a network communication unit 140.

The antenna 101 is used to send and receive radio signals. The radio communication unit 110 is formed of a radio frequency (RF) circuit, a baseband (BB) circuit and the like, for example, and exchanges radio signals with the radio terminal UE connected to the radio base station eNB#1 via the antenna 101. In addition, the radio communication unit 110 modulates transmission signals and demodulates reception signals.

The controller 120 is formed of a CPU, for example, and controls various functions of the radio base station eNB#1. The storage 130 is formed of a memory, for example, and stores therein various kinds of information used for control and the like of the radio base station eNB#1. The network communication unit 140 performs inter-base station communication with the radio base station eNB#2 over the X2 interface. A power supply 150 supplies power to each of the blocks of the radio base station eNB#1.

The controller 120 includes a connected-terminal determination unit 121, an inactive-state notification unit 122, and a power consumption controller 123.

The connected-terminal determination unit 121 determines whether or not any radio terminal UE is connected to the radio base station eNB#1. The determination is made according to usage of a frequency resource or a radio bearer, or information from an MME. Information on the result of determination made by the connected-terminal determination unit 121 is inputted to the inactive-state notification unit 122.

When the connected-terminal determination unit 121 determines that there is no radio terminal UE connected to the radio base station eNB#1, the inactive-state notification unit 122 generates an eNB Configuration Update message including Deactivation Indication IE (deactivation information) indicating that the radio base station eNB#1 is switched to an inactive state of reduced power consumption. Here, an inactive state refers to a state where at least some of the blocks of the radio base station eNB#1 are turned off (power supply thereto is stopped), or where power supply to at least some of the blocks of the radio base station eNB#1 is reduced. In the inactive state, it is preferable that power supply to at least the radio communication unit 110 being a block consuming a large amount of power be stopped. The eNB Configuration Update message including Deactivation Indication IE (deactivation information) is inputted to the network communication unit 140.

The network communication unit 140 sends the eNB Configuration Update message to the radio base station eNB#2 over the X2 interface. Additionally, the network communication unit 140 receives an eNB Configuration Update Acknowledge message being a response to the eNB Configuration Update message over the X2 interface.

When the network communication unit 140 receives the eNB Configuration Update Acknowledge message, the power consumption controller 123 controls the power supply 150 so that the radio base station eNB#1 is switched to the inactive state. For example, the power consumption controller 123 controls the power supply 150 so that at least some of the blocks of the radio base station eNB#1 are turned off, or power supply to at least some of the blocks of the radio base station eNB#1 is reduced.

In addition, the network communication unit 140 receives a Cell Activation Request message for switching the radio base station eNB#1 to an active state from the radio base station eNB#2 over the X2 interface. Then, the network communication unit 140 sends a Cell Activation Response message being a response to the Cell Activation Request message to the radio base station eNB#2 over the X2 interface.

The power consumption controller 123 controls the power supply 150 so that the radio base station eNB#1 is switched from the inactive state to the active state when the network communication unit 140 sends the Cell Activation Request message. For example, the power consumption controller 123 controls the power supply 150 so that power supply is resumed to the blocks which were turned off, or power supply is returned to the original state to the blocks to which power supply had been reduced.

### (1.3.2) Configuration of Radio Base Station eNB#2

FIG. 4 is a block diagram showing the configuration of the radio base station eNB#2 of the first embodiment.

As shown in FIG. 4, the radio base station eNB#2 includes an antenna 201, a radio communication unit 210, a controller 220, a storage 230, and a network communication unit 240.

The antenna 201 is used to send and receive radio signals. The radio communication unit 210 is formed of a radio frequency (RF) circuit, a baseband (BB) circuit and the like, for example, and exchanges radio signals with the radio terminal UE via the antenna 201. In addition, the radio communication unit 210 modulates transmission signals and demodulates reception signals.

The controller 220 is formed of a CPU, for example, and controls various functions of the radio base station eNB#2. The storage 230 is formed of a memory, for example, and stores therein various kinds of information used for control and the like of the radio base station eNB#2. The network communication unit 240 performs inter-base station communication with the radio base station eNB#1 over the X2 interface. A power supply 250 supplies power to each of the blocks of the radio base station eNB#2.

The network communication unit 240 receives an eNB Configuration Update message including Deactivation Indication IE (deactivation information) from the radio base station eNB#1 over the X2 interface. Thus, the network communication unit 240 corresponds to a receiver for receiving deactivation information from the radio base station eNB#1 (the first radio base station). Additionally, the network communication unit 240 sends an eNB Configuration Update Acknowledge message to the radio base station eNB#1 over the X2 interface.

The controller 220 includes a location-information acquisition unit 221A, a connected-terminal determination unit 222, and an activation request unit 223.

The location-information acquisition unit 221A acquires location information on each of the radio terminals UE connected to the radio base station eNB#2. Note that the location-information acquisition unit 221A may acquire location information only when the network communication unit 240 sends an eNB Configuration Update Acknowledge message.

The location-information acquisition unit 221A may acquire location information according to the following techniques, for example.

(Location information acquisition method 1) If the radio terminals UE connected to the radio base station eNB#2 have a positioning function according to GPS (Global Positioning System), the location-information acquisition unit 221A acquires location information generated by GPS for each of the radio terminals UE.

(Location information acquisition method 2) If the radio terminals UE connected to the radio base station eNB#2 do not have a positioning function according to GPS, the location-information acquisition unit 221A acquires location information on each of the radio terminals UE from a location management server (E-SLMC: Evolved Serving Mobile Location Center) provided on the core network side. Refer to 3GPP TS36.305 for details on the location management server (E-SLMC).

(Location information acquisition method 3) Based on measurement reports received from each of the radio terminals UE connected to the radio base station eNB#2, a location of the radio terminal UE is estimated from states of radio signals that the radio terminal UE receives from multiple radio base stations.

(Location information acquisition method 4) If the cell C#2 formed by the radio base station eNB#2 is divided into sectors, broad location information on the radio terminal UE can be acquired according to information such as path loss between the radio terminal UE and the radio base station eNB#2 in a sector corresponding to the direction of the radio base station eNB#1.

After the network communication unit 240 receives the eNB Configuration Update message including Deactivation indication IE, the connected-terminal determination unit 222 makes the following determination. Specifically, the connected-terminal determination unit 222 determines, with reference to the location information acquired by the location-information acquisition unit 221A, whether or not the number of radio terminals UE connected to the radio base station eNB#2 and located within a predetermined area from the radio base station eNB#1 exceeds a predetermined number. Here, a predetermined area refers to an area of the cell C#1 formed by the radio base station eNB#1, for example. Information indicating the predetermined area is previously stored in the storage 230. In addition, the predetermined number is assumed to be a value not less than zero.

Assume a situation where the condition that the number of radio terminals UE connected to the radio base station eNB#2 and located within a predetermined area from the radio base station eNB#1 exceeds a predetermined number is satisfied. This situation indicates that the one or more radio terminals UE connected to the radio base station eNB#2 may switch its connection destination to the radio base station eNB#1.

When the connected-terminal determination unit 222 determines that the number of radio terminals UE connected to the radio base station eNB#2 and located within a predetermined area from the radio base station eNB#1 exceeds a predetermined number, the activation request unit 223 generates a Cell Activation Request message (activation request) for switching the radio base station eNB#1 to the active state.

The network communication unit 240 sends the generated Cell Activation Request message to the radio base station eNB#1 over the X2 interface. Thus, the network communication unit 240 corresponds to a transmitter for sending an activation request to the radio base station eNB#1 (the first radio base station). Then, the network communication unit 240 receives a Cell Activation Response message being a response to the Cell Activation Request message from the radio base station eNB#1 over the X2 interface.

### (1.4) Operation of Radio Communication System

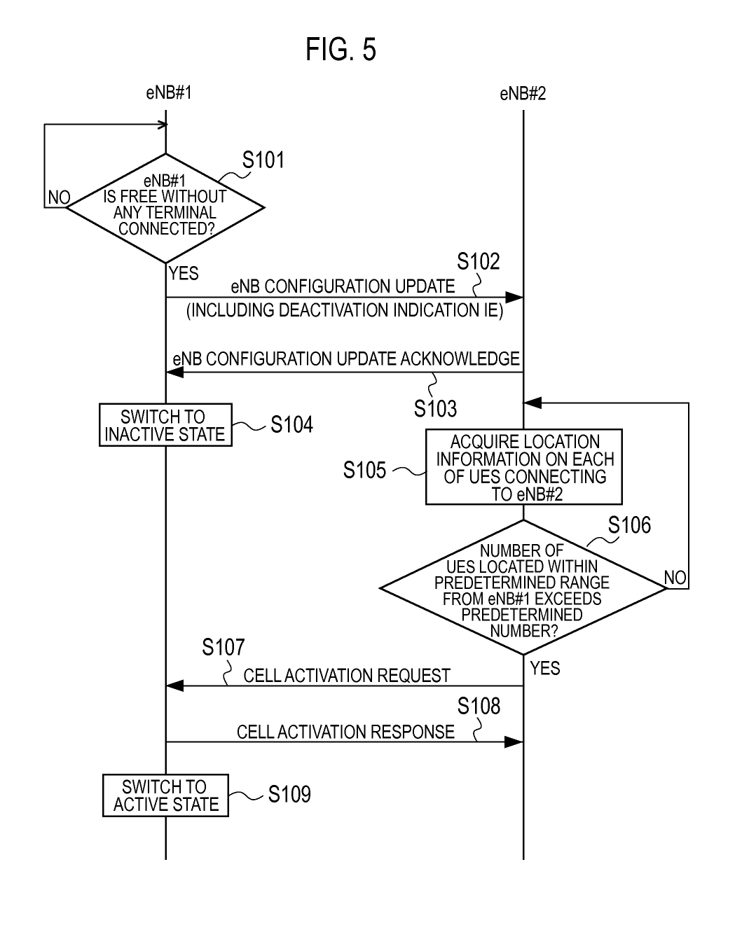

FIG. 5 is an operation sequence chart showing an operation of the radio communication system 1A of the first embodiment.

In step S101, the connected-terminal determination unit 121 of the radio base station eNB#1 determines whether or not any radio terminal UE is connected to the radio base station eNB#1. If there is no radio terminal UE connected to the radio base station eNB#1, the processing proceeds to step S102.

In step S102, the inactive-state notification unit 122 of the radio base station eNB#1 generates an eNB Configuration Update message including Deactivation Indication IE. The network communication unit 140 of the radio base station eNB#1 sends the generated eNB Configuration Update message to the radio base station eNB#2 over the X2 interface. The network communication unit 240 of the radio base station eNB#2 receives the eNB Configuration Update message including Deactivation Indication IE.

In step S103, the network communication unit 240 of the radio base station eNB#2 sends an eNB Configuration Update Acknowledge message being a response to the eNB Configuration Update message to the radio base station eNB#1 over the X2 interface. The network communication unit 140 of the radio base station eNB#1 receives the eNB Configuration Update Acknowledge message.

In step S104, the power consumption controller 123 of the radio base station eNB#1 controls the power supply 150 so that the radio base station eNB#1 is switched to the inactive state. For example, the power consumption controller 123 controls the power supply 150 so that at least some of the blocks of the radio base station eNB#1 are turned off, or power supply to at least some of the blocks of the radio base station eNB#1 is reduced.

In step S105, the location-information acquisition unit 221A of the radio base station eNB#2 uses one of the aforementioned (Location information acquisition method 1) to (Location information acquisition method 4) to acquire location information indicating the location of the radio terminal UE connected to the radio base station eNB#2, for each of the radio terminals UE.

In step S106, the connected-terminal determination unit 222 of the radio base station eNB#2 determines, with reference to the location information acquired by the location-information acquisition unit 221A, whether or not the number of radio terminals UE connected to the radio base station eNB#2 and located within a predetermined area from the radio base station eNB#1 exceeds a predetermined number. When the number of radio terminals UE connected to the radio base station eNB#2 and located within the predetermined area from the radio base station eNB#1 exceeds the predetermined number, the processing proceeds to step S107.

In step S107, the activation request unit 223 of the radio base station eNB#2 generates a Cell Activation Request message (activation request) for switching the radio base station eNB#1 to the active state. Then, the network communication unit 140 sends the generated Cell Activation Request message to the radio base station eNB#1 over the X2 interface. The network communication unit 140 of the radio base station eNB#1 receives the Cell Activation Request message.

In step S108, the network communication unit 140 of the radio base station eNB#1 sends a Cell Activation Response message to the radio base station eNB#2 over the X2 interface. The network communication unit 240 of the radio base station eNB#2 receives the Cell Activation Response message.

In step S109, the power consumption controller 123 of the radio base station eNB#1 controls the power supply 150 so that the radio base station eNB#1 is switched from the inactive state to the active state. For example, the power consumption controller 123 controls the power supply 150 so that power supply is resumed to the blocks which were turned off, or power supply is returned to the original state to the blocks to which power supply had been reduced.

### (1.5) Effects of First Embodiment

As has been described, when the radio base station eNB#2 of the first embodiment receives the eNB Configuration Update message including Deactivation Indication IE, and then the number of radio terminals UE connected to the radio base station eNB#2 and located within the predetermined area from the radio base station eNB#1 exceeds the predetermined number, the radio base station eNB#2 sends the Cell Activation Request message for switching the radio base station eNB#1 to the active state to the radio base station eNB#1.

With this configuration, power consumption of the radio base station eNB#1 can be reduced, while the radio base station eNB#1 can be switched to the active state in consideration of the possibility that the radio terminal UE connected to the radio base station eNB#2 switches its connection destination to the radio base station eNB#1. Hence, it is possible to prevent deterioration in quality of service provided to the radio terminal UE connected to the radio base station eNB#2.

According to the first embodiment, it is possible to provide a favorable service to the radio terminals UE connected to the radio base station eNB#2, while cutting down power consumption of the radio base station eNB#1.

### (2) Second Embodiment

Next, a second embodiment of the present invention will be described with respect to (2.1) configuration of radio base station, (2.2) operation of radio base station, and (2.3) effects of second embodiment in this order. Note, however, that descriptions are mainly given on points different from the first embodiment, and redundant descriptions are omitted.

### (2.1) Configuration of Radio Base Station

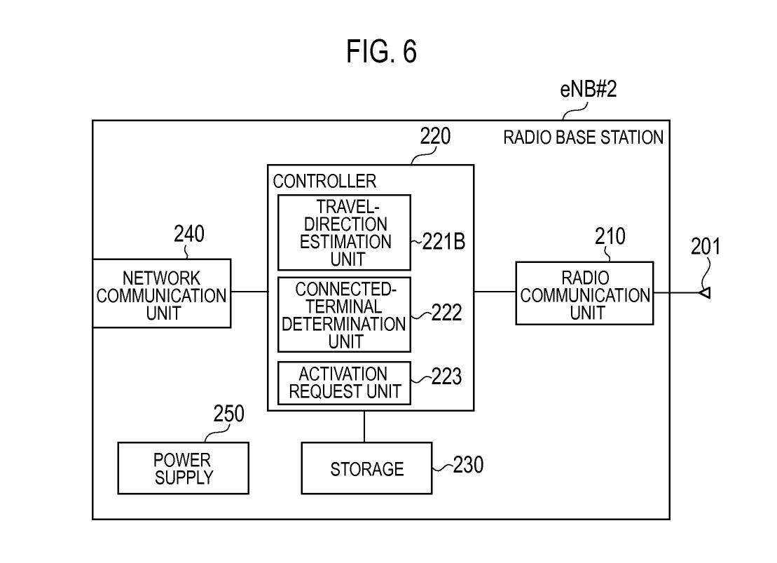

In the second embodiment, the configuration of the radio base station eNB#2 differs from the first embodiment, while the configuration of the radio base station eNB#1 is the same as the first embodiment. For this reason, the configuration of the radio base station eNB#2 will be described. FIG. 6 is a block diagram showing the configuration of the radio base station eNB#2 of the second embodiment.

As shown in FIG. 6, the radio base station eNB#2 of the second embodiment includes a travel-direction estimation unit 221B in place of the location-information acquisition unit 221A described in the first embodiment.

The travel-direction estimation unit 221B estimates a travel direction of the radio terminal UE connected to the radio base station eNB#2 for each of the radio terminals UE. The travel-direction estimation unit 221B may estimate a travel direction according to the following techniques, for example.

(Travel direction estimation method 1) If the radio terminals UE have a positioning function according to GPS (Global Positioning System), the travel-direction estimation unit 221B estimates the travel direction of each radio terminal UE on the basis of location information on at least two positions of the radio terminal UE generated by GPS.

(Travel direction estimation method 2) If the radio terminals UE do not have a positioning function according to GPS, the travel-direction estimation unit 221B estimates the travel direction of each radio terminal UE by acquiring location information on at least two positions of the radio terminal UE from a location management server (E-SLMC: Evolved Serving Mobile Location Center) provided on the core network side.

(Travel direction estimation method 3) Based on measurement reports received from each of the radio terminals UE connected to the radio base station eNB#2, the travel direction of the radio terminal UE is estimated by estimating at least two positions of the radio terminal UE from states of radio signals that the radio terminal UE receives from multiple radio base stations.

(Travel direction estimation method 4) If the cell C#2 formed by the radio base station eNB#2 is divided into sectors, a radio terminal UE traveling toward the radio base station eNB#1 can be identified according to information such as path loss between the radio terminal UE and the radio base station eNB#2 in a sector corresponding to the direction of the radio base station eNB#1.

After the network communication unit 240 receives the eNB Configuration Update message including Deactivation indication IE, the connected-terminal determination unit 222 makes the following determination. Specifically, the connected-terminal determination unit 222 determines, according to the travel direction of each radio terminal UE estimated by the travel-direction estimation unit 221B, whether or not the number of radio terminals UE connected to the radio base station eNB#2 and traveling toward the radio base station eNB#1 (to be specific, toward the cell C#1 formed by the radio base station eNB#1) exceeds a predetermined number. Here, the predetermined number is assumed to be a value not less than zero. Note that information on the direction of the radio base station eNB#1 (specifically, the cell C#1) is previously stored in the storage 230.

Assume a situation where the condition that the number of radio terminals UE connected to the radio base station eNB#2 and traveling toward the radio base station eNB#1 exceeds a predetermined number is satisfied. This situation indicates that the one or more radio terminals UE connected to the radio base station eNB#2 may switch its connection destination to the radio base station eNB#1.

When the connected-terminal determination unit 222 determines that the number of radio terminals UE connected to the radio base station eNB#2 and traveling toward the radio base station eNB#1 exceeds a predetermined number, the activation request unit 223 generates a Cell Activation Request message for switching the radio base station eNB#1 to the active state.

The network communication unit 240 sends the generated Cell Activation Request message to the radio base station eNB#1 over the X2 interface. Then, the network communication unit 240 receives a Cell Activation Response message being a response to the Cell Activation Request message from the radio base station eNB#1 over the X2 interface.

### (2.2) Operation of Radio Communication System

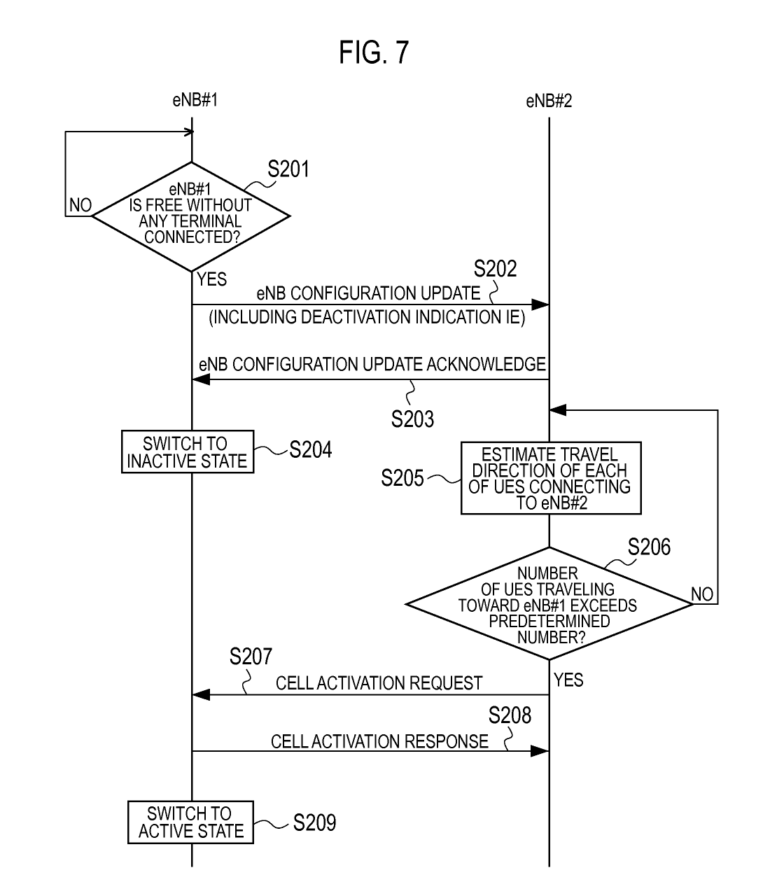

FIG. 7 is an operation sequence chart showing an operation of the radio communication system 1A of the second embodiment.

In step S201, the connected-terminal determination unit 121 of the radio base station eNB#1 determines whether or not any radio terminal UE is connected to the radio base station eNB#1. If there is no radio terminal UE connected to the radio base station eNB#1, the processing proceeds to step S202.

In step S202, the inactive-state notification unit 122 of the radio base station eNB#1 generates an eNB Configuration Update message including Deactivation Indication IE. The network communication unit 140 of the radio base station eNB#1 sends the generated eNB Configuration Update message to the radio base station eNB#2 over the X2 interface. The network communication unit 240 of the radio base station eNB#2 receives the eNB Configuration Update message including Deactivation Indication IE.

In step S203, the network communication unit 240 of the radio base station eNB#2 sends an eNB Configuration Update Acknowledge message being a response to the eNB Configuration Update message to the radio base station eNB#1 over the X2 interface. The network communication unit 140 of the radio base station eNB#1 receives the eNB Configuration Update Acknowledge message.

In step S204, the power consumption controller 123 of the radio base station eNB#1 controls the power supply 150 so that the radio base station eNB#1 is switched to the inactive state. For example, the power consumption controller 123 controls the power supply 150 so that at least some of the blocks of the radio base station eNB#1 are turned off, or power supply to at least some of the blocks of the radio base station eNB#1 is reduced.

In step S205, the travel-direction estimation unit 221B of the radio base station eNB#2 uses one of the aforementioned (Travel direction estimation method 1) to (Travel direction estimation method 4) to estimate the travel direction of each of the radio terminals UE connected to the radio base station eNB#2.

In step S206, the connected-terminal determination unit 222 of the radio base station eNB#2 determines, according to the travel direction estimated by the travel-direction estimation unit 221B, whether or not the number of radio terminals UE connected to the radio base station eNB#2 and traveling toward the radio base station eNB#1 exceeds a predetermined number. When the number of radio terminals UE connected to the radio base station eNB#2 and traveling toward the radio base station eNB#1 exceeds the predetermined number, the processing proceeds to step S207.

In step S207, the activation request unit 223 of the radio base station eNB#2 generates a Cell Activation Request message for switching the radio base station eNB#1 to the active state. Then, the network communication unit 140 sends the generated Cell Activation Request message to the radio base station eNB#1 over the X2 interface. The network communication unit 140 of the radio base station eNB#1 receives the Cell Activation Request message.

In step S208, the network communication unit 140 of the radio base station eNB#1 sends a Cell Activation Response message to the radio base station eNB#2 over the X2 interface. The network communication unit 240 of the radio base station eNB#2 receives the Cell Activation Response message.

In step S209, the power consumption controller 123 of the radio base station eNB#1 controls the power supply 150 so that the radio base station eNB#1 is switched from the inactive state to the active state. For example, the power consumption controller 123 controls the power supply 150 so that power supply is resumed to the blocks which were turned off, or power supply is returned to the original state to the blocks to which power supply had been reduced.

### (2.3) Effects of Second Embodiment

As has been described, when the radio base station eNB#2 of the second embodiment receives the eNB Configuration Update message including Deactivation Indication IE, and then the number of radio terminals UE connected to the radio base station eNB#2 and traveling toward the radio base station eNB#1 exceeds the predetermined number, the radio base station eNB#2 sends the Cell Activation Request message for switching the radio base station eNB#1 to the active state to the radio base station eNB#1.

With this configuration, power consumption of the radio base station eNB#1 can be reduced, while the radio base station eNB#1 can be switched to the active state in consideration of the possibility that the radio terminal UE connected to the radio base station eNB#2 switches its connection destination to the radio base station eNB#1. Hence, it is possible to prevent deterioration in quality of service provided to the radio terminal UE connected to the radio base station eNB#2.

According to the second embodiment, it is possible to provide a favorable service to the radio terminal UE connected to the radio base station eNB#2, while cutting down power consumption of the radio base station eNB#1.

### (3) Third Embodiment

Next, a third embodiment will be described with respect to (3.1) configuration of radio base station, (3.2) operation of radio communication system, and (3.3) effects of third embodiment in this order. Note, however, that descriptions are mainly given on points different from the first embodiment, and redundant descriptions are omitted.

### (3.1) Configuration of Radio Base Station

In the third embodiment, the configuration of the radio base station eNB#2 differs from the first embodiment, while the configuration of the radio base station eNB#1 is the same as the first embodiment. For this reason, the configuration of the radio base station eNB#2 will be described.

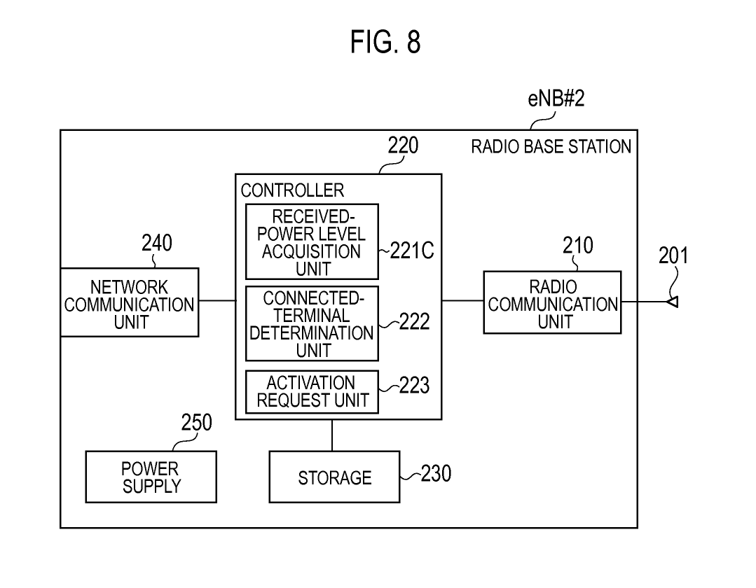

FIG. 8 is a block diagram showing the configuration of the radio base station eNB#2 of the third embodiment.

As shown in FIG. 8, the radio base station eNB#2 of the third embodiment includes a received-power level acquisition unit 221C in place of the location-information acquisition unit 221A described in the first embodiment.

The received-power level acquisition unit 221C acquires a level of power received from the radio base station eNB#2 for each radio terminal UE connected to the radio base station eNB#2. The radio terminal UE measures a received power level of a reference signal received from the radio base station eNB (RSRP: Reference Signal Received Power), and sends a report (measurement report) including measured values of the received power levels to the radio base station eNB to which the radio terminal UE is connected. Hence, the received-power level acquisition unit 221C can acquire the level of power received from the radio base station eNB#2 for each radio terminal UE, by referring to the measurement reports received by the radio communication unit 210 from the radio terminals UE connected to the radio base station eNB#2.

After the network communication unit 240 receives the eNB Configuration Update message including Deactivation indication IE, the connected-terminal determination unit 222 makes the following determination. Specifically, the connected-terminal determination unit 222 determines, by comparing the received power level of each radio terminal UE acquired by the received-power level acquisition unit 221C with a threshold, whether or not the number of radio terminals UE connected to the radio base station eNB#2 and having a lower level of power received from the radio base station eNB#2 than the threshold exceeds a predetermined number. Note that the threshold is previously stored in the storage 230.

Assume a situation where the condition that the level of power received from the radio base station eNB#2 of the radio terminal UE connected to the radio base station eNB#2 falls below the threshold is satisfied. This situation indicates that the radio terminal UE may switch its connection destination to the radio base station eNB#1.

When the connected-terminal determination unit 222 determines that the number of radio terminals UE connected to the radio base station eNB#2 and having a lower level of power received from the radio base station eNB#2 than the threshold exceeds a predetermined number, the activation request unit 223 generates a Cell Activation Request message for switching the radio base station eNB#1 to the active state.

The network communication unit 240 sends the generated Cell Activation Request message to the radio base station eNB#1 over the X2 interface. Then, the network communication unit 240 receives a Cell Activation Response message being a response to the Cell Activation Request message from the radio base station eNB#1 over the X2 interface.

### (3.2) Operation of Radio Communication System

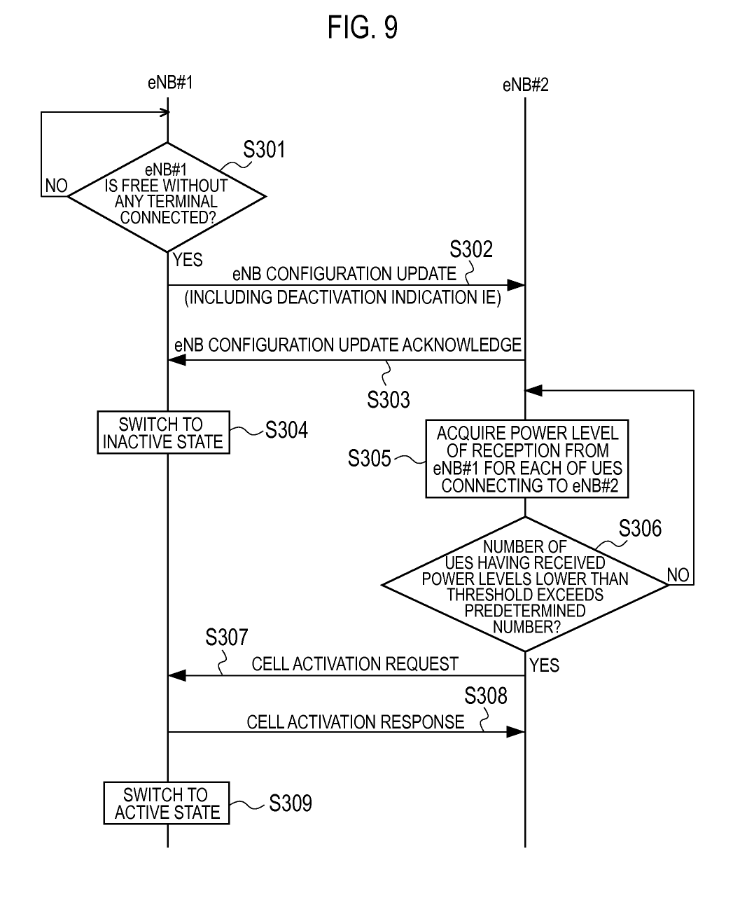

FIG. 9 is an operation sequence chart showing an operation of the radio communication system 1A of the third embodiment.

In step S301, the connected-terminal determination unit 121 of the radio base station eNB#1 determines whether or not any radio terminal UE is connected to the radio base station eNB#1. If there is no radio terminal UE connected to the radio base station eNB#1, the processing proceeds to step S302.

In step S302, the inactive-state notification unit 122 of the radio base station eNB#1 generates an eNB Configuration Update message including Deactivation Indication IE. The network communication unit 140 of the radio base station eNB#1 sends the generated eNB Configuration Update message to the radio base station eNB#2 over the X2 interface. The network communication unit 240 of the radio base station eNB#2 receives the eNB Configuration Update message including Deactivation Indication IE.

In step S303, the network communication unit 240 of the radio base station eNB#2 sends an eNB Configuration Update Acknowledge message being a response to the eNB Configuration Update message to the radio base station eNB#1 over the X2 interface. The network communication unit 140 of the radio base station eNB#1 receives the eNB Configuration Update Acknowledge message.

In step S304, the power consumption controller 123 of the radio base station eNB#1 controls the power supply 150 so that the radio base station eNB#1 is switched to the inactive state. For example, the power consumption controller 123 controls the power supply 150 so that at least some of the blocks of the radio base station eNB#1 are turned off, or power supply to at least some of the blocks of the radio base station eNB#1 is reduced.

In step S305, the received-power level acquisition unit 221C of the radio base station eNB#2 refers to the measurement report to thereby acquire the level of power received from the radio base station eNB#2 for each radio terminal UE connected to the radio base station eNB#2.

In step S306, the connected-terminal determination unit 222 of the radio base station eNB#2 determines, with reference to the received power level acquired by the received-power level acquisition unit 221C, whether or not the number of radio terminals UE connected to the radio base station eNB#2 and having a lower level of power received from the radio base station eNB#2 than the threshold exceeds a predetermined number. When the number of radio terminals UE connected to the radio base station eNB#2 and having a lower level of power received from the radio base station eNB#2 than the threshold exceeds the predetermined number, the processing proceeds to step S307.

In step S307, the activation request unit 223 of the radio base station eNB#2 generates a Cell Activation Request message for switching the radio base station eNB#1 to the active state. Then, the network communication unit 140 sends the generated Cell Activation Request message to the radio base station eNB#1 over the X2 interface. The network communication unit 140 of the radio base station eNB#1 receives the Cell Activation Request message.

In step S308, the network communication unit 140 of the radio base station eNB#1 sends a Cell Activation Response message to the radio base station eNB#2 over the X2 interface. The network communication unit 240 of the radio base station eNB#2 receives the Cell Activation Response message.

In step S309, the power consumption controller 123 of the radio base station eNB#1 controls the power supply 150 so that the radio base station eNB#1 is switched from the inactive state to the active state. For example, the power consumption controller 123 controls the power supply 150 so that power supply is resumed to the blocks which were turned off, or power supply is returned to the original state to the blocks to which

### (3.3) Effects of Third Embodiment

As has been described, when the radio base station eNB#2 of the third embodiment receives the eNB Configuration Update message including Deactivation Indication IE, and then the number of radio terminals UE connected to the radio base station eNB#2 and having a lower level of power received from the radio base station eNB#2 than the threshold exceeds the predetermined number, the radio base station eNB#2 sends the Cell Activation Request message for switching the radio base station eNB#1 to the active state to the radio base station eNB#1.

With this configuration, power consumption of the radio base station eNB#1 can be reduced, while the radio base station eNB#1 can be switched to the active state in consideration of the possibility that the radio terminal UE connected to the radio base station eNB#2 switches its connection destination to the radio base station eNB#1. Hence, it is possible to prevent deterioration in quality of service provided to the radio terminal UE connected to the radio base station eNB#2.

According to the third embodiment, it is possible to provide a favorable service to the radio terminal UE connected to the radio base station eNB#2, while cutting down power consumption of the radio base station eNB#1.

### (4) Other Embodiments

As mentioned above, the present invention has been described according to the embodiments. However, it should not be understood that the discussions and the drawings constituting a part of this disclosure limit the present invention. From this disclosure, various alternative embodiments, examples and operational techniques will be apparent to those skilled in the art.

### (4.1) Modified Example of Control performed by Radio Base Station eNB#1

In the above embodiments, the connected-terminal determination unit 121 of the radio base station eNB#1 determines whether or not any radio terminal UE is connected to the radio base station eNB#1. However, the determination method is not limited to this, and the following determination methods may also be used. For example, the connected-terminal determination unit 121 may determine whether or not the number of radio terminals UE connected to the radio base station eNB#1 is not more than a predetermined number, and each of the radio terminals UE receives a reference signal from another radio base station at a power level not lower than a threshold. Here, the received power level is based on a measurement report. Then, when the connected-terminal determination unit 121 determines that the number of radio terminals UE connected to the radio base station eNB#1 is not more than the predetermined number, and each of the radio terminals UE receives a reference signal from another radio base station at a power level not lower than the threshold, the inactive-state notification unit 122 generates an eNB Configuration Update message including Deactivation Indication IE (deactivation information) indicating that the radio base station eNB#1 is switched to the inactive state.

### (4.2) Modified Example of Radio Communication System

Although descriptions have been given in the above embodiments of a radio base station in which a radio communication unit and a controller are provided integrally, a radio base station (RRH: Remote Radio Head) whose controller is provided outside may be used instead.

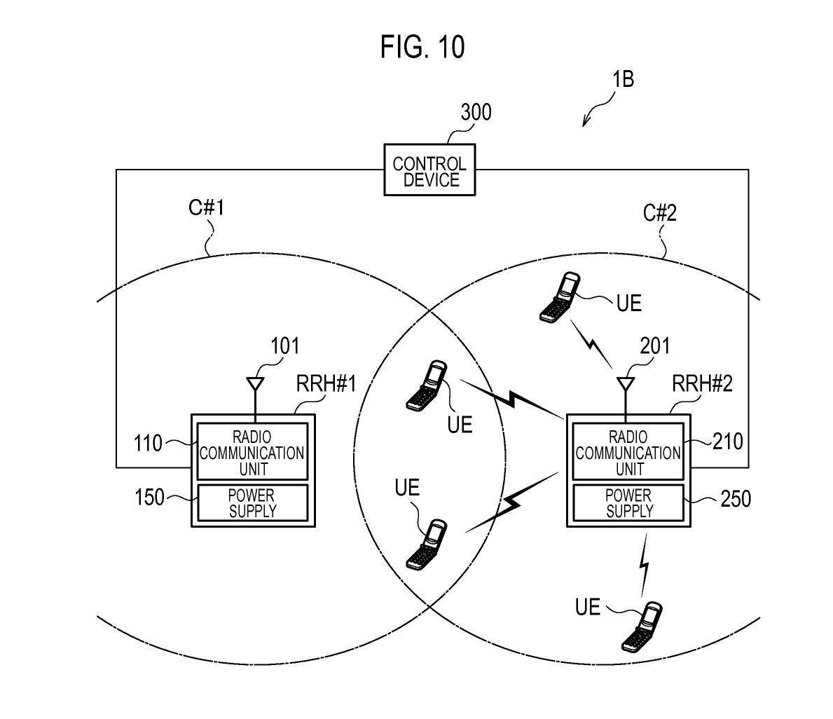

FIG. 10 is a schematic configuration diagram showing a schematic configuration of a radio communication system 1B of another embodiment.

As shown in FIG. 10, the radio communication system 1B includes a radio base station RRH#1 forming a cell C#1, a radio base station RRH#2 in the neighborhood of the radio base station RRH#1 and forming a cell C#2, and a control device 300 controlling the radio base station RRH#1 and the radio base station RRH#2. In the first embodiment, the radio base station RRH#1 corresponds to the first radio base station, the radio base station RH#2 corresponds to the second radio base station, and the control device 300 corresponds to the controller.

The radio base station RRH#1 includes an antenna 101, a radio communication unit 110, and a power supply 150. The antenna 101 is used to send and receive radio signals. The radio communication unit 110 is formed of a radio frequency (RF) circuit, for example, and exchanges radio signals with the radio terminals UE connected to the radio base station RHH#1 via the antenna 101. The power supply 150 supplies power to the radio communication unit 110 when the radio base station RRH#1 is in an active state, and stops the power supply to the radio communication unit 110 when the radio base station RRH#1 is in an inactive state.

The radio base station RRH#2 includes an antenna 201, a radio communication unit 210, and a power supply 250. The antenna 201 is used to send and receive radio signals. The radio communication unit 210 is formed of a radio frequency (RF) circuit, for example, and exchanges radio signals with the radio terminals UE connected to the radio base station RHH#2 via the antenna 201. The power supply 250 supplies power to the radio communication unit 210 when the radio base station RRH#2 is in an active state, and stops the power supply to the radio communication unit 210 when the radio base station RRH#2 is in an inactive state.

The control device 300 has the same function as the controller 120 and the controller 220 described above. The control device 300 performs control such that the radio base station RRH#1 in the inactive state is switched to the active state depending on the states of the radio terminals connected to the radio base station eNB#2.

According to the first embodiment, the control device 300 performs control such that the radio base station RRH#1 is switched from the inactive state to the active state, when the number of radio terminals UE connected to the radio base station RRH#2 and located within a predetermined area from the radio base station RRH#1 exceeds a predetermined number.

According to the second embodiment, the control device 300 performs control such that the radio base station RRH#1 is switched from the inactive state to the active state, when the number of radio terminals UE connected to the radio base station RRH#2 and traveling toward the radio base station RRH#1 (the cell C#1) exceeds a predetermined number.

According to the third embodiment, the control device 300 performs control such that the radio base station RRH#1 is switched from the inactive state to the active state, when the number of radio terminals UE connected to the radio base station RRH#2 and having a lower level of power received from the radio base station RRH#2 than a threshold exceeds a predetermined number.

### (4.3) Applications of Embodiments

The descriptions of the above embodiments have been given of a radio communication system according to LTE (3GPP Release 8 or 9). However, in LTE Advanced (3GPP Release 10) of improved LTE, provision of a heterogeneous network including multiple types of radio base stations having different transmission powers is scheduled. The present invention is also applicable to such a heterogeneous network. Moreover, in LTE Advanced, provision of a relay node being a radio base station forming backhaul by radio waves is also scheduled. Such a relay node may also be used as the radio base station of the present invention.

Furthermore, although the above embodiments have been described using an LTE system, the present invention is also applicable to other radio communication systems such as a radio communication system according to mobile WiMAX (IEEE 802.16e).

As mentioned above, the present invention includes various embodiments and the like which are not described herein. Accordingly, the present invention should be limited only by the matters defining the invention described in the scope of the claims which is appropriate from this disclosure.

Note that the entire content of the Japanese Patent Application No. 2010-140007 (filed on Jun. 18, 2010) is incorporated herein by reference.

### INDUSTRIAL APPLICABILITY

As mentioned above, the radio communication system, the radio base station, and the communication control method of the present invention is useful for radio communication such as mobile communication, by which a favorable service to the radio terminal can be provided, while power consumption of the radio base station is reduced.

1. A radio communication system comprising:
a first radio base station capable of being switched from an active state to an inactive state in which the first radio base station consumes less power than in the active state;
a second radio base station in the neighborhood of the first radio base station; and
a controller configured to perform control when the first radio base station is in the inactive state, such that the first radio base station is switched from the inactive state to the active state depending on a condition of a radio terminal connected to the second radio base station.

2. The radio communication system according to claim 1, wherein:
the first radio base station sends, to the second radio base station, deactivation information indicating that the first radio base station is switched to the inactive state,
the second radio base station comprises:
the controller;
a receiver configured to receive the deactivation information from the first radio base station; and
a transmitter capable of sending, to the first radio base station, an activation request for switching the first radio base station to the active state, and
after the receiver receives the deactivation information, the controller controls the transmitter so that the transmitter sends the activation request to the first radio base station, depending on the situation of the radio terminal connected to the second radio base station.

3. The radio communication system according to claim 2, wherein after the receiver receives the deactivation information, the controller controls the transmitter so that the transmitter sends the activation request to the first radio base station, when at least one radio terminal connected to the second radio base station satisfies a condition for switching its connection destination to the first radio base station.

4. The radio communication system according to claim 2, wherein after the receiver receives the deactivation information, the controller controls the transmitter so that the transmitter sends the activation request to the first radio base station, when the number of radio terminals connected to the second radio base station and located within a predetermined area from the first radio base station exceeds a predetermined number.

5. The communication system according to claim 2, wherein after the receiver receives the deactivation information, the controller controls the transmitter so that the transmitter sends the activation request to the first radio base station, when the number of radio terminals connected to the second radio base station and traveling toward the first radio base station exceeds a predetermined number.

6. The communication system according to claim 2, wherein after the receiver receives the deactivation information, the controller controls the transmitter so that the transmitter sends the activation request to the first radio base station, when the number of radio terminals connected to the second radio base station and having a lower level of power received from the second radio base station than a threshold exceeds a predetermined number.

7. A radio base station comprising:
a receiver configured to receive deactivation information from other radio base station in the neighborhood of the radio base station, the deactivation information indicating that the other radio base station is switched to an inactive state of reduced power consumption;
a transmitter capable of sending the other radio base station an activation request for switching the other radio base station from the inactive state to an active state; and
a controller configured to control the transmitter so that the transmitter sends the activation request to the other radio base station depending on a situation of a radio terminal connected to the radio base station, after the receiver receives the deactivation information.

8. A communication control method comprising the steps of:
sending deactivation information from a first radio base station to a second radio base station in the neighborhood of the first radio base station, the deactivation information indicating that the first radio base station is switched to an inactive state of reduced power consumption;
receiving the deactivation information from the first radio base station by the second radio base station; and
after receiving the deactivation information, sending an activation request from the second radio base station to the first radio base station, the activation request being for switching the first radio base station from the inactive state to an active state depending on a situation of a radio terminal connected to the second radio base station.
